(19) United States
(12) Patent Application Publication
(10) Pub. No.: US 2025/0091055 A1
(43) Pub. Date: Mar. 20, 2025

(54) APPARATUSES AND METHODS FOR PRODUCING PARTICLES

(71) Applicants: Marc Sima, Alar (ES); Antonijo Licitar, Zagreb (HR)

(72) Inventors: Marc Sima, Alar (ES); Antonijo Licitar, Zagreb (HR)

(21) Appl. No.: 18/823,888

(22) Filed: Sep. 4, 2024

(30) Foreign Application Priority Data
Sep. 19, 2023 (EP) 23382949

(51) Int. Cl. B02C 19/00; B01J 6/00

(52) U.S. Cl. CPC B02C 19/005; B01J 6/00; B02C 13/205

(57) ABSTRACT

The present disclosure relates to an apparatus for producing nanoparticles of a material, including: a core for accelerating the material, wherein the core can include a first disc and a second disc facing the first disc, and one or more drives for rotating the first disc, the second disc, or a combination thereof, wherein the first disc and the second disc each can include a plurality of concentric rings, wherein each of the plurality of the concentric rings can include a blade base and a plurality of hypersonic blades arranged on the blade base; and a plurality of concentric channels alternately interleaved with the plurality of concentric rings. A method for producing nanoparticles of a material using the apparatus is also described.

### CROSS-REFERENCE TO RELATED APPLICATIONS

This application claims priority to European Application No. 23382949 filed on Sep. 19, 2023, which is hereby incorporated by reference in its entirety.

### FIELD

The present disclosure relates to apparatuses for producing particles, particularly nanoparticles, as well as top-down methods for producing particles using such apparatuses. The apparatuses of the present disclosure may process dry material as well as liquid and gaseous materials.

### BACKGROUND

Nanoparticles have at least one of their dimensions, optionally all their dimensions, between 1 nm and 100 nm. As the surface area to volume ratio of the material increases in the nanoscale, the properties of the nanoparticles may be different from the properties of larger particles. Nanoparticles are used in a wide range of fields, for example, medicine, electronics, materials science, and others.

One known method for obtaining nanoparticles involves a mechanical mill, disclosed in U.S. Pat. Nos. 11,154,868 B2 and 11,607,693 B2, which are incorporated by reference herein in their entirety. In these documents, two rotors including aerodynamical blades which can be rotated in opposite directions are described. However, it has been discovered that these designs are not capable of producing more than about 5% of nanoparticles from the input material. Additionally, blade damage and abrasion occur which further reduce the efficiency of these systems. The input material collides with the blades, breaking down due to the collisions with the blades and deteriorating the blades themselves. The material removed from the blades may contaminate the environment and may produce nanoparticles which include impurities.

There remains a need for systems and methods that can efficiently produce nanoparticles with minimal impurities and reduced damage to the system. The present disclosure aims at resolving and reducing one or more of the above mentioned disadvantages.

### SUMMARY

In some aspects, the techniques described herein relate to an apparatus for producing nanoparticles of a material, including: a core for accelerating the material, wherein the core includes: a first disc and a second disc facing the first disc, and one or more drives for rotating the first disc, the second disc, or a combination thereof, wherein the first disc and the second disc each include: a plurality of concentric rings, wherein each of the plurality of the concentric rings includes a blade base and a plurality of hypersonic blades arranged on the blade base; a plurality of concentric channels alternately interleaved with the plurality of concentric rings; wherein each of the plurality of hypersonic blades includes a sharp leading edge, a sharp trailing edge, a suction surface, and a pressure surface configured to produce an expansion wave; wherein each of the plurality of hypersonic blades of the plurality of concentric rings of the first disc are arranged in the channels of the second disc; and wherein each of the plurality of hypersonic blades of the plurality of concentric rings of the second disc are arranged in the channels of the first disc.

In some aspects, the techniques described herein relate to an apparatus, wherein the one or more drives are configured to rotate the first disc in a first direction and the second disc in a second direction, opposite to the first direction.

In some aspects, the techniques described herein relate to an apparatus, further including: an inlet for introducing the material in the apparatus; and a material guide for guiding the material to the core.

In some aspects, the techniques described herein relate to an apparatus, wherein the first disc, the second disc, or a combination thereof include an opening through which material is drawn into the core when the first disc, the second disc, or a combination thereof are rotated.

In some aspects, the techniques described herein relate to an apparatus, further including a system for setting an atmosphere within a path of the apparatus through which the material is to travel.

In some aspects, the techniques described herein relate to an apparatus, further including a system for generating a vacuum for removing the nanoparticles of the material from the core.

In some aspects, the techniques described herein relate to an apparatus, further including a separator system for separating the nanoparticles of the material from a surrounding medium.

In some aspects, the techniques described herein relate to an apparatus, further including a collection system configured to collect the nanoparticles of the material.

In some aspects, the techniques described herein relate to an apparatus, wherein a chord length of each of the plurality of hypersonic blades decreases from a most radially inner ring towards a most radially outer ring.

In some aspects, the techniques described herein relate to an apparatus, wherein a pitch of each of the plurality of hypersonic blades increases from a radially most inner ring towards a radially most outer ring.

In some aspects, the techniques described herein relate to an apparatus, wherein the first disc and the second disc include a ceramic material.

In some aspects, the techniques described herein relate to an apparatus, wherein the core further includes: a housing enclosing the first disc and the second disc; wherein the housing further includes one or more elements for acting on an atmosphere between the first disc and the second disc.

In some aspects, the techniques described herein relate to an apparatus, further configured to adjust a sintering process within the core.

In some aspects, the techniques described herein relate to a method for producing nanoparticles of a material, including: rotating the first disc, the second disc, or a combination thereof of an apparatus including: a core for accelerating the material, wherein the core includes: a first disc and a second disc facing the first disc, and one or more drives for rotating the first disc, the second disc, or a combination thereof, wherein the first disc and the second disc each include: a plurality of concentric rings, wherein each of the plurality of the concentric rings includes a blade base and a plurality of hypersonic blades arranged on the blade base; a plurality of concentric channels alternately interleaved with the plurality of concentric rings; wherein each of the plurality of hypersonic blades includes a sharp leading edge, a sharp trailing edge, a suction surface, and a pressure surface configured to produce an expansion wave; thereby drawing the material into the core; accelerating the material; and colliding the material between the plurality of hypersonic blades of the first disc and the plurality of hypersonic blades of the second disc, thereby producing nanoparticles of the material.

In some aspects, the techniques described herein relate to a method, further including modifying an atmosphere within the core.

In some aspects, the techniques described herein relate to a method, further including colliding the material a plurality of times.

In some aspects, the techniques described herein relate to a method, further including producing hydrogen during the colliding of the material.

In some aspects, the techniques described herein relate to a method, further including adding an additive to the core.

In some aspects, the techniques described herein relate to a method, wherein the additive includes silicon, nickel, graphene, activated carbon, potassium hydroxide, sodium hydroxide, or combinations thereof.

In some aspects, the techniques described herein relate to a method, further including sintering the nanoparticles of the material.

### BRIEF DESCRIPTION OF THE DRAWINGS

Aspects, features, benefits, and advantages of the embodiments described herein will be apparent with regard to the following description, appended claims, and accompanying drawings where:

FIG. 1 schematically illustrates a side view of an example of a core for accelerating and colliding material for producing particles, according to an embodiment of the present disclosure.

FIG. 2 schematically illustrates a bottom view of the first disc including the hypersonic blades, according to an embodiment of the present disclosure.

FIG. 3 schematically illustrates a cross-section of an example of the first disc and the second disc, according to an embodiment of the present disclosure.

FIG. 4 schematically illustrates a top view of the first element which supports the first disc including the hypersonic blades, according to an embodiment of the present disclosure.

FIG. 5 schematically illustrates an example of a geometry and arrangement of the hypersonic blades in a disc which includes the blades, according to an embodiment of the present disclosure.

FIG. 6A schematically illustrates a perspective view of an apparatus including a core according to the disclosure. FIG. 6B schematically illustrates a front view of the apparatus of FIG. 6A, according to an embodiment of the present disclosure.

FIG. 7 schematically illustrates another example of an apparatus, the apparatus including a plurality of cores, according to an embodiment of the present disclosure.

### DETAILED DESCRIPTION

The present disclosure describes systems and methods for producing nanoparticles of a material. The production of nanoparticles is a commercially valuable process, as many high-value materials are desired at the nanoparticle-scale. The present disclosure describes systems and methods which can efficiently produce nanoparticles with few defects as well as minimizing damage to the apparatus and components.

### Apparatus for Producing Nanoparticles

In embodiments, there is provided an apparatus for producing nanoparticles of a material, including: a core for accelerating the material, wherein the core includes a first disc and a second disc facing the first disc, and one or more drives for rotating the first disc, the second disc, or a combination thereof, wherein the first disc and second disc each include a plurality of concentric rings, wherein each of the plurality of the concentric rings includes a blade base and a plurality of hypersonic blades arranged on the blade base; a plurality of concentric channels alternately interleaved with the plurality of concentric rings; wherein each of the plurality of hypersonic blades includes a sharp leading edge, a sharp trailing edge, a suction surface, and a pressure surface configured to produce an expansion wave; wherein each of the plurality of hypersonic blades of the plurality of concentric rings of the first disc are arranged in the channels of the second disc; and wherein each of the plurality of hypersonic blades of the plurality of concentric rings of the second disc are arranged in the channels of the first disc.

Other examples of apparatuses and methods for producing nanoparticles of a material can be found in European Patent Application Nos. 23217348, 23217346, and 23383307, all of which are incorporated by reference herein in their entirety.

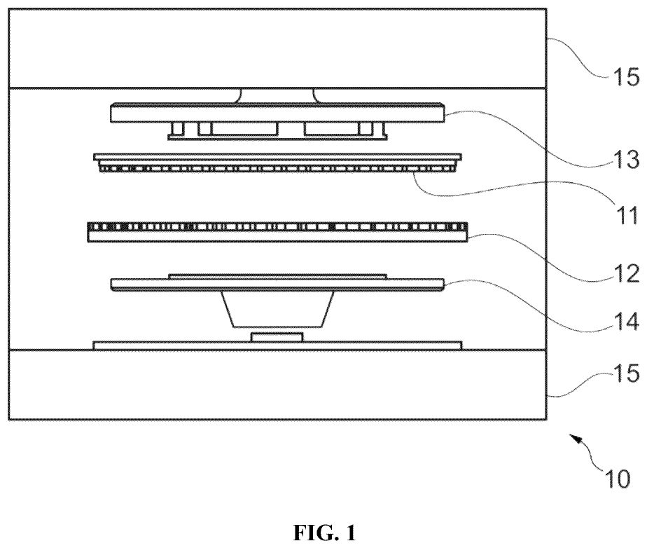

FIG. 1 schematically illustrates a side and an exploded view of an example of a core 10 for accelerating and colliding material with itself for producing particles, optionally nanoparticles. Such a core may be used in an apparatus as described herein for producing particles of a smaller size and/or for sintering a material.

In embodiments, the core 10 can include a first disc 11 including hypersonic blades and a second opposite disc 12 including hypersonic blades. In embodiments, the core 10 further includes a first supporting element 13 for supporting the first disc 11 and a second supporting element 14 for supporting the second disc 12.

In embodiments, the core 10 can further include a housing 15 enclosing at least the first disc 11 and the second disc 12. The housing 15 may form a chamber in which the first disc 11 and the second disc 12 are arranged. The first and second supporting elements 13, 14 may be configured to connect with a corresponding portion of the housing 15. Although in the example of FIG. 1, a disc is provided as a separate piece from a corresponding supporting element, in other embodiments the discs may be integrally formed, or any suitable support for the first disc 11 and second disc 12, as well as any suitable coupling between the discs and a shaft or the housing 15, may also be included.

In embodiments, a disc 11, 12 including hypersonic blades and a supporting element 13, 14 may form a rotor. In embodiments, a disc 11, 12 including hypersonic blades and a supporting element 13, 14 may form a stator. At least one the discs 11, 12 including blades may be rotatable. Both discs may be rotatable, or one of the discs may be rotatable. If both discs are rotatable, they may be rotated in a same direction or in opposite directions. The orientation of the hypersonic blades and the direction of rotation of the discs may be adjusted for suitably drawing the material into the core and accelerating the material inside the core 110 and between the discs 11, 12 including the hypersonic blades. In embodiments, both discs are rotated in opposite directions.

The pairs of discs 11, 12 including hypersonic blades and the supporting elements 13, 14 may be directly or indirectly connected to a corresponding shaft. In embodiments, the discs can be connected to the corresponding shaft by a hydraulic coupling system or a magnetic coupling system. Bearings such as ceramic bearings may be provided. In embodiments, a drive may be provided for rotating the shaft, and therefore rotating the corresponding disc and the hypersonic blades thereof. In embodiments, one or more electric motors may be provided. The motors may be AC motors, brushless DC electric motors, or other suitable motors for rotating the shaft. Other suitable actuators for rotating the shaft at high speed may alternatively be provided. The one or more drives and may be arranged outside the core 10 and the coupling may be magnetic, in embodiments, so as to avoid contamination.

In the embodiment of FIG. 1, the first disc 11 and the second 12 disc can be arranged in a vertical configuration (rotation about a vertical axis). In other embodiments, the first 11 and second 12 discs may be arranged in a horizontal configuration (rotation about a horizontal axis), or in a different configuration.

In embodiments, the channels formed on the second disc can surround, at least in part, the hypersonic blades of the first disc, and vice versa.

Therefore, in a disc of the core, rings including blades are alternated with rings not including blades. In addition, the rings not including the blades form channels, such that there is a difference in height, herein measured along the axial direction of the core, between the base of a channel and the base on which a blade is arranged. In this manner, the channels of one of the discs can surround, at least in part, the blades of the other disc.

In embodiments, the blades can be hypersonic blades. In embodiments, a hypersonic blade may include a shape similar to a kite or a diamond in cross-section, that is, in a plane taken perpendicular to the axial direction of the core, and therefore of each of the discs.

These two aspects, namely the difference in height between the channel base and the blade base which allows the channels to surround the blades of the other disc, and the shape of the blades help to prevent, or at least to reduce, the collision or impact of the input material with the blades. Rather, a portion of the input material collides with another portion of the input material, for producing particles of the material of smaller dimensions that the input material. As the first disc, the second disc, or a combination thereof rotate, the input material may be drawn into the core and between the two discs. Therefore, the input material may be dragged to the inside of the core, instead of pushed to the inside of core.

Throughout this disclosure, a sharp leading and trailing edge means that the edges are not rounded. For example, instead of an edge of a local region being rounded, the edge may include two adjacent edge portions which meet in a vertex and have a given angle between them, for example an angle less than or equal to 180° or less than or equal to 90°. The suction and pressure surfaces of the blades may have a similar sharp transition point, which is configured to produce an expansion wave.

Throughout this disclosure, a hypersonic blade may refer to a blade having the shape indicated above. In embodiments, the shape of the blades may help to accelerate the input material and cause the material to reach speeds of rotation similar to the ones of the disc. Collisions of the input material with the blades may therefore be avoided or at least reduced.

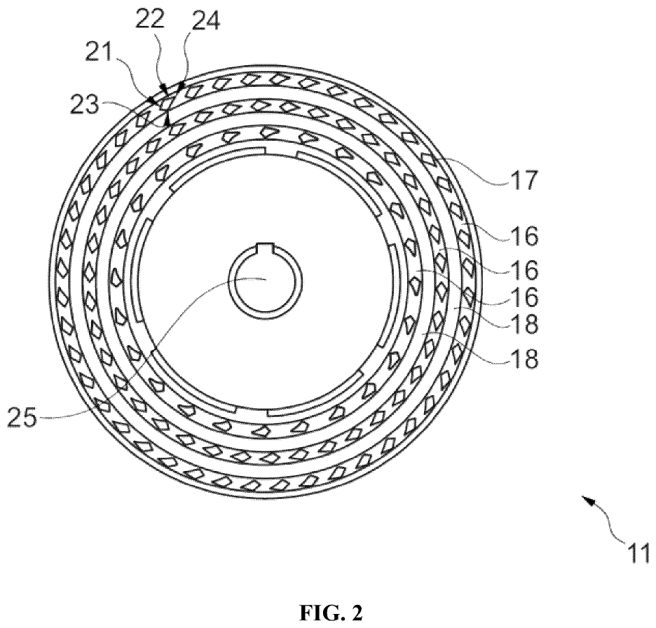

FIG. 2 schematically illustrates a bottom view of the first disc 11 including the hypersonic blades of FIG. 1. The first disc 11, and also the second disc 12, include a first plurality of concentric rings 16. Each ring 16 includes a blade base and a plurality of hypersonic blades 17 arranged on the blade base configured to draw the material to be accelerated and collided into the core. The first disc 11, and also the second disc 12, further include a second plurality of concentric channels 18 alternately interleaved with the first plurality of concentric rings 16. A central opening 25 through which material can be drawn into the core 10 when the first disc 11 and/or the second 12 disc are rotated can also be seen in this figure.

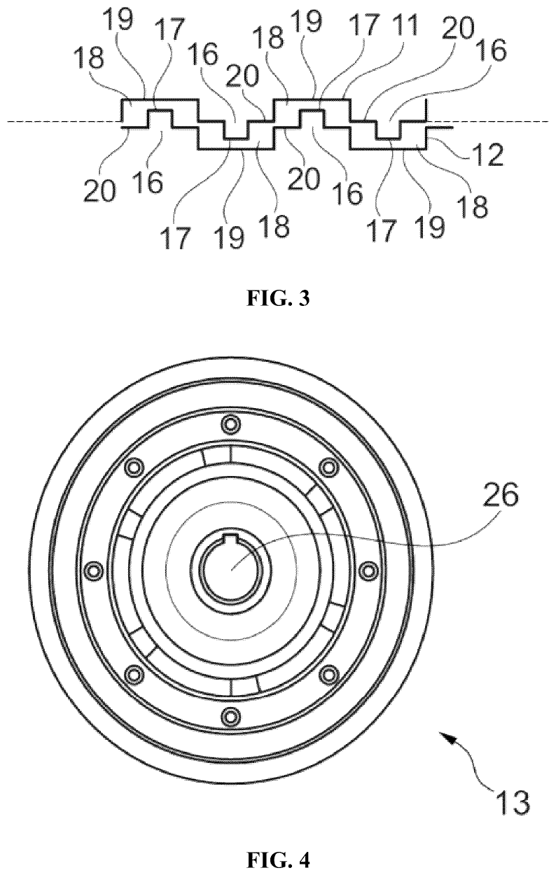

FIG. 3 schematically illustrates a cross-section of an example of the first disc 11 and the second disc 12 facing each other. The cross-section is taken in a plane which includes the axial and radial directions of the core 11. As can be seen in FIG. 3, the channels 18 alternate with the blade rings 16 in each disc. Additionally, the channels 18 of a disc can surround, at least in part, the hypersonic blades 17 of the other disc. Each channel 18 includes a channel base 19, and the channel bases 19 are offset from the blade bases 20 along an axial direction of the core 10. A side wall of a blade ring 16 and a side wall of a channel ring 18 may be shared, that is, a single wall may form the side wall of blade ring 16 and of blade ring 18. A channel 18 may have a U-shape or hat-shape, in embodiments.

As can also be seen in FIG. 3, the hypersonic blades 17 of the first plurality of concentric rings 18 of the first disc 11 are arranged in the channels 18 formed by the second plurality of concentric rings of the second disc 12 such that the channels 18 formed by the second plurality of concentric rings surround at least in part the hypersonic blades 17 of the first plurality of concentric rings 16. Similarly, the hypersonic blades 17 of the first plurality of concentric rings 16 of the second disc 12 are arranged in the channels 18 formed by the second plurality of concentric rings of the first disc 11 such that the channels 18 formed by the second plurality of concentric rings surrounds at least in part the hypersonic blades 17 of the first plurality of concentric rings 16.

The hypersonic blades 17 may be integrally formed with the portion of the disc supporting them, or they may be formed separately, and then attached to the corresponding portion of the disc.

A gap (in an axial direction) between the two discs 11, 12 may be adjusted as needed. In embodiments, such a gap may be about 1 micron to about 2 mm, for example about 200 microns to about 2 mm, or any value contained within a range formed by any two of the preceding values. In embodiments, a gap of about 500 microns may be used.

In the embodiment of FIG. 2, the hypersonic blades 17 can include a sharp leading edge 21, a suction surface 22, and a pressure surface 23 with a sharp transition point and a sharp trailing edge 24. This shape helps to draw the input material between the first 11 and second discs 12 when at least one of the discs is rotated. A shape and size of the blades 17 in a blade ring 16 may be the same, or the shape and/or the size of the blades 17 may vary between blade rings 16, in embodiments. The shape, pitch, chord length, or combinations thereof of the blades may be adjusted in each ring and may vary such that with increasing distance to the center, the speed of movement of the blades will increase.

The leading edges 23 of the hypersonic blades 17 of the first disc 11 may point in a same circumferential direction of the first disc 11. The leading edges 23 of the hypersonic blades 17 of the second disc 12 may point in the opposite circumferential direction; in embodiments, the discs with blades are rotated in opposite directions.

Additionally, a chord length of the blade (the length between the leading edge 23 and the trailing edge 24) of the hypersonic blades 17 of a ring 18 of the first disc 11 may decrease from a most radially inner ring towards a most radially outer ring of the first disc 11. Similarly, a length between the leading edge 23 and the trailing edge 24v of the hypersonic blades 17 of a ring 16 of the second disc 12 may decrease from a most radially inner ring towards a most radially outer ring of the second disc 12.

A pitch, the distance along the circumferential direction between leading edges of two consecutive blades, may increase from a most inner ring towards a most outer ring of the first disc 11 in a radial direction of the first disc 11. The same may apply to the blades of the second disc.

In embodiments, the first disc 11 and the second disc 12 may include a ceramic material. This includes the blades 17, which may include a ceramic material.

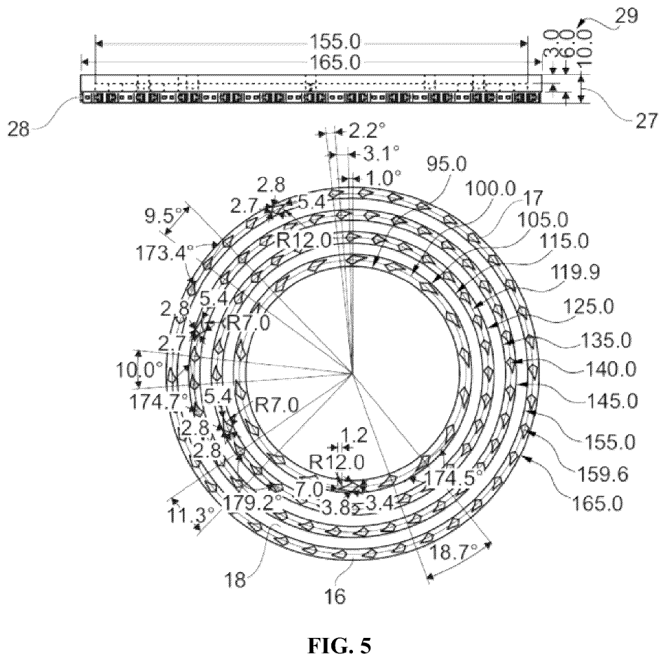

FIG. 4 schematically illustrates a top view of the first element 13 which supports the first disc 11 including the hypersonic blades 17 of FIG. 1. As can be seen in FIG. 4, a central opening 26 is provided in this example for allowing the passage of the input material towards an inside of the core 10.

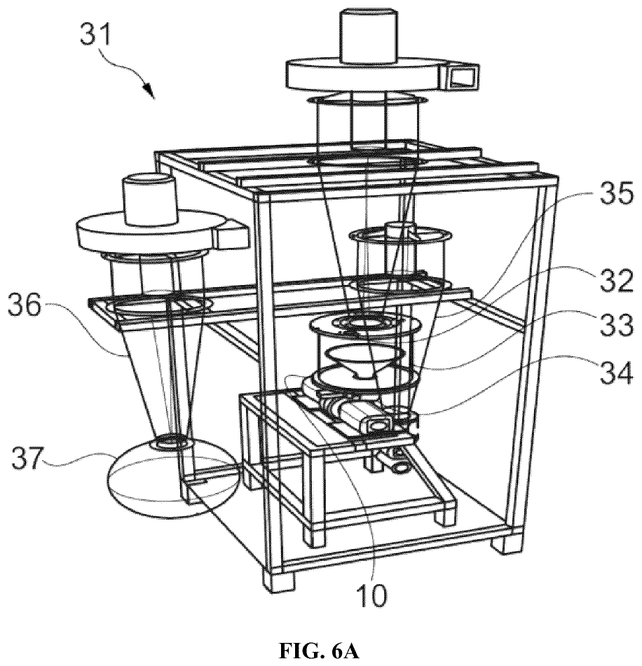

FIG. 5 schematically illustrates an example of a particular geometry and arrangement of the hypersonic blades 17 in a disc which includes the blades. In embodiments, several angles and sizes with respect to the blades 17 may be used. A total height 27 of a ring 16 including the blades 17, herein referring to a dimension along the axial direction of the disc, may be about 10 mm. A height 28 of the blades may be 4 mm, a height 29 of a ring 16 including the blades 17, but in a region between two blades, may be about 6 mm, and a height 30 of a ring 18 forming a channel may be 3 mm. Therefore, an axial distance between a channel base 19 and a blade base 20, that is, a channel depth, may be about 3 mm. A diameter of the disc may be about 165 mm.

In embodiments, the first disc, the second disc, or a combination thereof may include an opening, optionally an opening close to a center of the disc or a central opening, through which the material can be drawn into the core when the first disc, the second disc, or a combination thereof are rotated. The material may therefore be dragged between the disc from one axial side of the core, from the other axial side of the core, or even from both axial sides of the core. In embodiments, elements for suitably introducing and outputting a material into and out of the core may be provided at the entrance and at the exit of the core. For example, ejectors may be provided. Other elements for helping to transport the material may also be provided.

In embodiments, both discs may be rotated. In embodiments, both discs may be rotated in opposite directions. In other embodiments, one of the discs may be rotated, while the other is static. Rotation of at least one disc may be performed at greater than or equal to about 25,000 revolutions per minute (rpm) in embodiments, such as greater than or equal to about 40,000 rpm, greater than or equal to about 45,000 rpm, and so forth. A sufficiently high speed of rotation may accelerate the input material to hypersonic speeds (that is, a speed that exceeds five times the speed of sound or greater, depending on the diameter of the discs and other parameters). In other embodiments, different parameters may be used. The parameters, such as the size and orientation of the blades 17, may be varied depending on the material to be processed.

In embodiments, the leading edges of the hypersonic blades of the first disc may point in a same circumferential direction of the first disc, and the leading edges of the hypersonic blades of the second disc may point in a same circumferential direction of the second disc. The leading edges of the blades of the first disc may point in the same or a different direction of the leading edges of the blades of the second disc. The orientation of the hypersonic blades in each disc may be adjusted to the direction of rotation of the discs and to the input material used. If the discs are rotated in opposite directions, the leading edges of the blades of each disc may point in opposite directions. If the discs are rotated in a same direction, the leading edges of the blades of each disc may point in the same direction (the direction of rotation). Also, if the discs are rotated in the same direction, but at different rotational speeds, the leading edges of the blades of each disc may point in opposite directions.

Suitable drives or actuators may be provided for rotating at least one of the discs. For example, one or more motors, a gas-powered system, an electromagnetically powered system, the like, or combinations thereof may be used for inducing rotation. In embodiments, a flywheel may be connected to the disc(s) to be rotated for reducing mechanical stress during operation.

In embodiments, at least one of the discs may be rotated with a hydraulic system or a pneumatic system. In embodiments in which a pneumatic system is provided to rotate a disc, a gas which is introduced into the core may also be a gas which is used to drive the disc, and the core may be slightly under pressurized with respect to the pneumatic system. In this manner, leakage of the material inside the core may be avoided, or at least reduced, due to the pressure difference between the core and the pneumatic system. If gas from the pneumatic system enters the core, contamination may be avoided, as the gas in the pneumatic system and inside the core is the same. In embodiments, two tanks of a same gas, such as an inert gas, may be provided. Gas from one of the tanks may be introduced into the core to provide a specific atmosphere while gas from the other tank may be used to drive the pneumatic drive. In embodiments, the pneumatic system may include a turbine and a compressor, such that the gas from the corresponding tank may be compressed and used to move the turbine, and therefore to move the corresponding shaft and disc.

If a liquid is to be introduced in the core, the core should be liquid tight for avoiding damage to the surrounding elements of the apparatus. In embodiments, a non-contact coupling between a drive for rotating a shaft and the shaft may be provided. A suitable non-contact coupling can be a magnetic coupling. A magnetic coupling may, for example, include permanent magnets or electromagnets. A non-contact coupling may help to avoid or at least reduce the risk of having liquid or humidity leaking from the core and damaging the drive. As lubricants may be dispensed with the non-contact coupling, a non-contact coupling may also help achieve a smoother operation of the apparatus and to transfer the energy from the drive to the shaft more efficiently.

In embodiments, a chord length between the leading edge and the trailing edge of the hypersonic blades of a ring of the first disc may decrease from a most radially inner ring towards a most radially outer ring of the first disc, and a chord length between the leading edge and the trailing edge of the hypersonic blades of a ring of the second disc may decrease from a most radially inner ring towards a most radially outer ring of the second disc. This configuration can help create a lower pressure at an outer radial portion of the discs, draw the input material to an inside of the core and to accelerate the material, and to cause an angular rotational speed of the material between the discs to increase towards an outer radial direction of the core. Colliding the input material and reducing the input material to a desired size may therefore be faster.

In embodiments, a pitch of the hypersonic blades of a ring of the first disc may increase from a most inner ring towards a most outer ring of the first disc in a radial direction of the first disc. Similarly, a pitch of the hypersonic blades of a ring of the second disc may increase from a most inner ring towards a most outer ring of the second disc in a radial direction of the second disc. This configuration can also help drag the input material between the discs and crush it to smaller sizes in an efficient manner.

In embodiments, the first disc and the second disc can include a ceramic material. In particular, the first disc and the second disc may be made entirely of a ceramic material. A ceramic coating may be used, in other embodiments. Colliding input materials which may show magnetic effects during the use of the core, including metals such as iron, may be particularly difficult to handle if the first and second discs include, or are made of, metallic materials. Using ceramic materials for the discs can help to collide such input materials effectively without undesirable side effects.

In embodiments, the apparatus can include one core or a plurality of cores. The core may therefore be referred to as a single stage core (one core) or a multistage core (plurality of cores). If the core is a multistage core, there may be a plurality of pairs of discs, each pair including a first disc and a second disc as described herein. In embodiments, all the first discs can be driven using a single actuator/drive such as a motor, and all the second discs are driven by another actuator, such as another motor. As explained further below, when the apparatus includes more than one core, the input material may be circulated through each of the cores in sequence for achieving a desired particle size and distribution. The apparatus may be configured such that the collided material may be directly collected from each of the cores in embodiments. It may also be possible to selectively direct and collide input material into specific cores, without having to circulate the input material through all of the cores available.

In embodiments, the core may further include a housing enclosing the first disc and the second disc. In embodiments, the apparatus can include one or more elements for acting on the atmosphere between the first disc and the second disc, or for acting on the material when it is introduced between the first and second discs, during the colliding process, or when the material is outputted from between the first and second discs. For example, a plurality of lasers may be provided in the housing, optionally in a circular arrangement, such that a plurality of laser beams may be applied to the collided material to be removed from between the discs. The collided material may have a softened crystal lattice after the collision process, and the properties of the collided material may be influenced by the laser beams. The lasers may be used to chemically reduce the collided material, that is, to cause the collided material to lose oxygen. Further action on the collided material, when it is still soft and has not yet reached a hardened crystal structure, may also be performed.

In embodiments, the housing 15 of the core 10 enclosing the first disc 11 and the second disc 12 may include one or more elements for acting on the atmosphere within the apparatus. For example, one or more of the following may be provided in the housing 15: a plasma torch, a magnetron, and a laser. A circular arrangement of lasers may be provided in the housing such that the lasers point to a small region through which the collided material is outputted.

In embodiments, the housing can include one or more plasma torches. The plasma torches may be used for sintering the material introduced between the first disc and the second disc. In other embodiments, the housing can include one or more magnetrons. A magnetron may be used to generate microwaves, which may be used to reduce the humidity level between the first disc and the second disc. Other suitable tools may alternatively or additionally be provided in the housing of the core.

In embodiments, a cooling system may be provided for cooling the core 10. For example, the core 10 may be air-cooled, or the housing may include conduits through which a cooling fluid may be circulated. In embodiments, a system for exfoliating graphene may also be provided in the core 10, such as in its housing 15. The system for exfoliating graphene may be configured to provide a high frequency and voltage.

In embodiments, one or more elements described herein may be configured to adjust a sintering process within the core 10. These elements may for example allow to control one or more of a pressure, a temperature, and a composition of the atmosphere inside the core 10. For example, at least some of the elements may be configured to allow to introduce a desired fluid such as a desired gas in the core 10.

Regarding sintering, the housing may include one or more elements suitable for enhancing the sintering of the material. In embodiments, one or more elements may be configured to adjust a sintering process within the core. For example, the housing may include one or more elements such as conduits or tubes for introducing one or more fluids, such as gases, which may help to sinter a material. In embodiments, one or more of these elements may be provided near an inlet for introducing the input material in the core. In embodiments, one or more elements may be provided near an outlet for removing the collided material from the core. The material which has been sintered may have a highly dense and stable structure. The housing of the collider may also include one or more elements for adjusting the sintering conditions. For example, temperature and pressure within the core may be adjusted with suitable elements. Additionally, the housing of the core may include one or more elements for inducing electron delocalization during the collision process, which may enhance sintering and densification of the material. Elements for enhancing the sintering of the material may also be provided in the apparatus after an outlet of the core, for example, in an ejector arranged after the core.

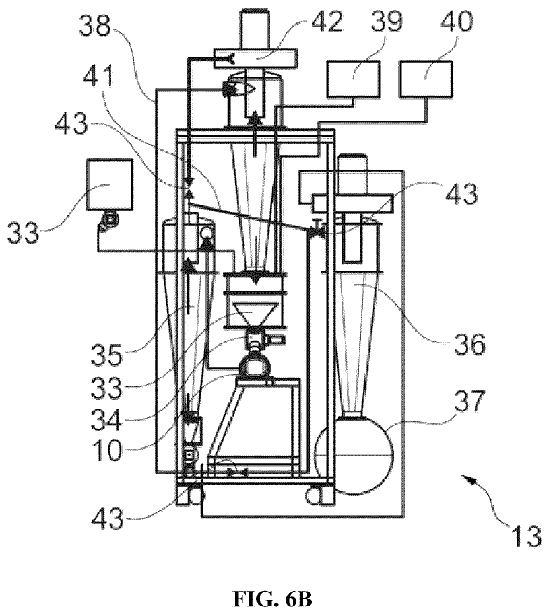

The core 10 may be incorporated in an apparatus. An example of an apparatus of the present disclosure is provided in FIGS. 6A and 6B. FIG. 6A schematically illustrates a perspective view of an apparatus including a core according to the disclosure. FIG. 6B schematically illustrates a front view of the apparatus of FIG. 6A.

In embodiments, the apparatus 31 can include a core 10 as described throughout this disclosure, an inlet 32 for introducing the material in the apparatus, and in particular in a path of the apparatus through which the material may travel, see FIG. 6A. The apparatus 31 further includes one or more elements connecting the inlet 32 and the core 10. As can be seen in FIG. 6B, a material source 32 may provide material to be introduced in the apparatus such that the material can reach the core 10.

In embodiments, the apparatus 31 may include a hopper 33. The hopper may hold the material introduced in it which is to be collided and may then dispense it. The apparatus 31 may be configured to dose the material to be introduced in the core 10. For example, the apparatus 31 may include a system 34 for dosing the material to be collided. Any suitable dosing system may be used. For example, a roto-valve may be used.

In embodiments, the apparatus may include a system 39, 40 for setting an atmosphere within a path of the apparatus through which the material is to travel. For example, the system may be configured to introduce a fluid in the apparatus for modifying an atmosphere within the apparatus. A fluid such as nitrogen (gas) may help to maintain a controlled level of oxygen during the production of the nanoparticles. A fluid such as argon (gas) may help to create a controlled environment for certain processing conditions. Other suitable fluids may be used. For example, the system 30, 40 may be configured to provide liquid nitrogen, which may help to achieve low temperatures. In embodiments, the system 39, 40 may include a vacuum pump for creating vacuum conditions.

In the embodiment of FIG. 6B, an element 40 for delivering a fluid and a vacuum pump 39 have been represented. In this embodiment, the element 40 for delivering a fluid and a vacuum pump 39 are fluidly connected to the hopper 33. In other embodiments, conditioning of the atmosphere may be provided in a different place. Conditioning of the atmosphere may be provided before the material is drawn into the core 10 for the first time at least in embodiments. In embodiments, vacuum may be performed, and then a fluid such as nitrogen may be introduced. The material may be introduced in the apparatus, for example in the hopper 33, once a desired atmosphere has been created.

In embodiments, the material added to the apparatus can be an input material, from which nanoparticles of the material are formed. It will generally be understood that “the material” refers to the input material, and that “nanoparticles of the material” refers to the final material that has been subjected to the apparatus of the present disclosure. The input material can be a powder-based material. As explained further below, the input material may be surrounded by a surrounding material, in particular a fluid, such as a gas or a liquid. In embodiments, the input material can be a dispersion or slurry. For example, a dispersion including salts, minerals, biological materials, or combinations thereof dissolved in a liquid may be used.

Nanosized materials, as well as materials of a larger size such as micron-sized materials, may be used as input in a sintering process. Slurries, dispersions, and gas mixtures including solid material may also be used as inputs for the core in the sintering process. The sintered material may be a nanosized material, or the sintered material may have larger dimensions. The sintered material may include two or more different materials, such as two or more nano-sized or micron-sized materials.

In embodiments, in addition to being configured for sintering, the apparatus may be configured for synthesizing a material. For example, two or more different materials may be introduced in the core of the apparatus, collided, and then bonded together in the presence of additional reactants that may be introduced to the core.

The material to be collided may therefore be introduced and guided to the core. Also, the collided material may be extracted from the core and guided away from the core through the apparatus. When the nanoparticles of the material have a desired size (or when the sintered/synthesized material has a desired size and/or properties), they may be removed from the apparatus. In embodiments, they may be collected in a collection system and then removed from the apparatus. The collection system may, in embodiments, include one or more glove boxes or hermetically sealed enclosures for ensuring stability, providing a controlled environment for the nanoparticles, and avoiding contamination. In other embodiments, the collided material of a desired size may be directly removed from the core. A collection system, which may include one or more ejectors, may be connected to the outlet of the core. If the apparatus includes a plurality of cores, a plurality of collections systems may be provided, and the collection systems may be connected to the outlets of the cores, such that collided material may be removed from each core and collected directly.

The apparatus may be configured to pass the material through the core more than once. If, after a colliding process in the core, there is material which does not have the desired size, this material which does not yet have the desired size may be directed through the core again. This process of directing the material through the core and colliding the material may be repeated a plurality of times.

In embodiments, the apparatus may further include a system for generating a vacuum or reduced pressure, for removing collided material from the core. The use of reduced pressure can be a suitable and efficient manner for removing the material from the core. A vacuum may herein be regarded as a significantly lower pressure than the working pressure in the core.

Vacuum may also be generated for preparing an atmosphere inside the apparatus before introducing the input material to be collided. For example, an inside of the apparatus may be washed and then vacuum may be applied for achieving a suitable atmosphere in the apparatus before introducing a material to be collided. Besides generating vacuum, or alternatively, one or more gases including inert gases may be introduced into the apparatus for preparing the atmosphere. The level of oxygen inside the apparatus may also be controlled, in embodiments.

The material to be collided may therefore be surrounded by a surrounding medium, at least in embodiments. Such a medium may include air or other fluids such as the ones introduced with the system 30, 40 for setting the atmosphere. As will be explained further below, the collided material may be separated from the surrounding medium after leaving the core 10. As mentioned with respect to the core 10, the surrounding medium may also be modified within the core 10 if, for example, a gas or another fluid is introduced into the core 10. In the core 10, both the input material and the surrounding medium may be accelerated.

The apparatus 31 may also include one or more actuators for rotating at least one of the first disc 11 and the second disc 12. An actuator may for example be a motor.

The apparatus 31 may include a system for generating a vacuum or reduced pressure for removing collided material from the core 10. In particular, the system may be configured to create a vacuum in an outlet of the core 10. In addition to aiding the removal of the collided material from the core 10, such a reduced pressure may also help to reduce friction within the core 10 and reduce collisions between the material and the hypersonic blades 17.

The apparatus may include a system for separating the collided material from a surrounding medium, in embodiments. In embodiments, the separation system and the system for generating a vacuum for removing the collided material from the core may be the same. Such a system may, for example, be a cyclonic separator. In embodiments, other systems such as a centrifugal separator, a gravity separation system, or an electropotential separation system may also be used.

In embodiments, the apparatus 31 may include a system 35 for separating the collided material from a surrounding medium. An example of such a system may be a cyclonic separator. A cyclonic separator may remove the collided material from a fluid such as a gas or a liquid. This may be achieved through gravity and rotational effects. System 35, such as a cyclonic separator, may be configured to separate material by size or density, in embodiments. The collided material may have different sizes, and the system 35 may separate the collided material in two or more groups according to size of the material. In embodiments, the system 35 for separating the collided material from a surrounding medium and the system for generating a vacuum for removing the collided material from the core 10 may be the same.

The collided material may include a portion of nanoparticles which have a desired size and are therefore ready to be collected, and may include a portion of nanoparticles or material of a larger size which has not yet reached the desired size. In embodiments, the nanoparticles which have reached the desired size may be directly removed from the apparatus 31. In other embodiments, the apparatus 31 may include a collection system 36 configured to collect the nanoparticles which have reached a desired size. Such a collection system 36 may include an element configured to draw the nanoparticles towards an inside of the collection system 36. The nanoparticles may, for example, go from the cyclonic separator to the collection system 36, see arrow 41 in FIG. 6B. The collection system 36 may include a storage element 37, from which the nanoparticles may be removed. In embodiments, the storage element 37 may be removable from the collection system 36.

The portion of the collided material which has not reached a desired sized may be directed to the core 10 to be collided again, see arrow 38 in FIG. 6B. The apparatus 31 may be configured to collide the material multiple times. For example, a turbo blower 42 may help to remove the corresponding collided material and guide it towards the core 10. The medium surrounding the collided material may also be directed to the core 10 after it has been separated from the collided material. One or more turbo blowers may be connected to the system 35 for separating the collided material from a surrounding medium in embodiments.

In embodiments, the produced nanoparticles (or sintered material) may be processed further after they are initially collided. In other embodiments, they may be directly collected and packed for storage after their production. The apparatus 31 may include a suitable system for packing the produced material, such as the produced nanoparticles, in a suitable manner. For example, the apparatus 31 may include a container-based system, including for example glow boxes, for packing the produced material. In embodiments, the apparatus may be arranged in a clean room. The clean room may include one or more systems for controlling the quality of the air, for example for filtering the air. Blankets such as water blankets may be provided for air filtration.

The apparatus may further include a system for controlling an atmosphere within a path of the apparatus through which the material is to travel. For example, the system may be configured to introduce a fluid, optionally a gas, in the apparatus for modifying an atmosphere within the apparatus. Introducing an inert gas such as nitrogen can help to regulate the level of oxygen within the apparatus. Argon is another inert gas which may help to create a controlled environment, in embodiments. The system may additionally or alternatively be configured to create a vacuum within the apparatus. For example, a vacuum pump may be provided. A controlled and suitable atmosphere for the production of nanoparticles can therefore be achieved. The apparatus may further include a drying system, a dehumidifying system, or a combination thereof.

In embodiments, the apparatus may further include a controller. The controller may be configured to control, manage, or coordinate the operation of the apparatus. The controller may have one or more processors and one or more memories with instructions which may be executed by the one or more processors. In embodiments, the apparatus may further include a plurality of sensors which may be communicatively coupled (through wires or wireless) to the controller. Examples of sensors may be temperature sensors, humidity sensors, pressure sensors, the like, or combinations thereof. The sensors can help to precisely control and adjust the operation of the apparatus in real time.

In embodiments, the apparatus may further include a plurality of valves which may be opened and closed for suitably operating the apparatus. Valves may help to control a flow through a fluid path within the apparatus. The valves may also help to regulate pressure. A plurality of valves 43 can also be seen in FIG. 6B. The valves may regulate the passage of a fluid through a path of the apparatus.

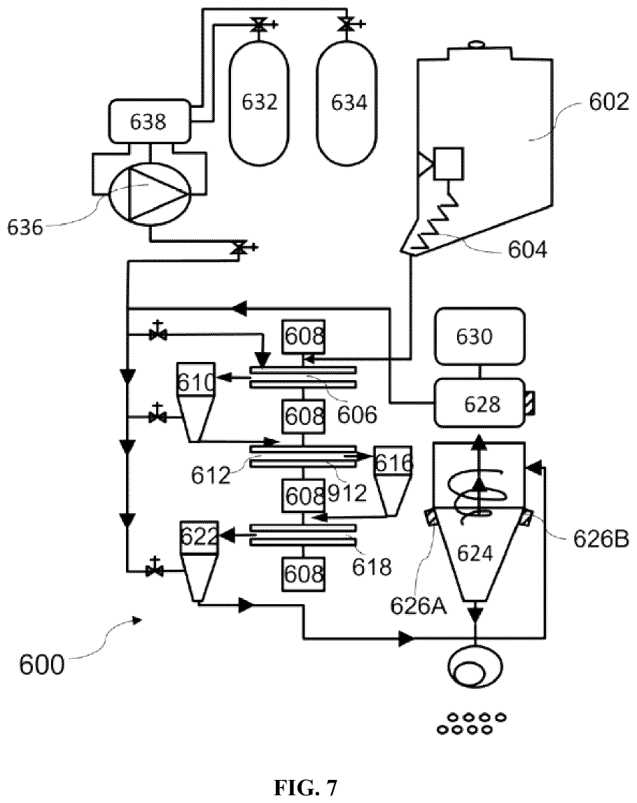

In embodiments, an apparatus may include more than one core. FIG. 7 schematically illustrates an example of an apparatus 600 which includes a plurality of cores, in particular three cores. Therefore, three stages may be provided: at the first stage, the input material is introduced into a first core 606. Once collided, the material is introduced into a first cyclonic separator 610. At the second stage, the collided material from the first stage which has been separated from the surrounding medium is introduced into a second core 912. The collided material is then passed through a second cyclonic separator 616. At the third stage, this material is introduced into a third core 618. The collided material in the third core 618 is separated from a surrounding medium once more in a third cyclonic separator 622. In the example of FIG. 7, a plurality of actuators 608 such as electric motors are used for rotating the first and second discs of each core 606, 912, 618.

In embodiments, the apparatus 600 may include or may be connected to a storage container 602 that stores an input material, which may be a powdered material. The input material may be delivered through a screw dozing system 604 into the first core 606 along with a surrounding medium, such as a gas.

In embodiments, the apparatus 600 may further include a fourth cyclonic separator 624 and a plurality of ultrasound generators 626A, 626B provided with the fourth cyclonic separator 520. When the particles outputted from the third cyclonic separator 622 travel through the fourth cyclonic separator 624, the ultrasound generated by the ultrasound generators 626A, 626B can help to palletize the produced particles. A pallet may have dimensions of a few microns, that is, a length of a pallet may be below 20 microns, in embodiments. A plurality of pallets may be stored in a cartridge.

In embodiments, the apparatus 600 may further include a turbo blower 628 for creating a vacuum or reduced pressure on the fourth cyclonic separator 624 and drawing the particles from the separator 624, such that they may be directed towards the first core 606, if the obtained particle size is larger than the desired particle size. An actuator 630 such as an electric motor may be provided for operating the turbo blower 628.

In embodiments, the apparatus 600 may further include a nitrogen generator 632 for maintaining a low-oxygen atmosphere during particle production. The nitrogen generator 632 may ensure a consistent and controlled level of oxygen during the production of the particles. The apparatus 600 may further include an inert gas tank 634 for providing an inert atmosphere. The nitrogen generator 632 and the inert gas tank 634 may be connected to a vacuum pump 636 through a valve station 638. The vacuum pump 636 may be provided to deprive the entire system of air. In embodiments, a vacuum may first be generated and then a path for the particles may be filled with an inert gas such as nitrogen.

In embodiments, the apparatus 600 may further include a plurality of sensors, for example flow sensors, temperature sensors, humidity sensors, pressure sensors, rotational speed sensors, or combinations thereof. The operation of the sensors may be controlled using a sensor control system. A control unit may control the operation of the apparatus 600 during the production of particles based on real-time data obtained by the sensors.

Aspects of the apparatus of FIG. 7 may be applied and combined with the apparatus of FIGS. 6A and 6B, and vice versa. For example, one or more ultrasound generators may be included in the apparatus of FIGS. 6A and 6B for palletizing the produced particles.

### Methods for Producing Nanoparticles

A core as described herein and an apparatus as described herein may be used to produce particles of a smaller size, such as nanoparticles. The apparatus as described herein may also be used to sinter a material, such as the material (in the form of nanoparticles) produced by the presently described apparatuses and methods. In another aspect, a method of operating the apparatus of the present disclosure is provided. The explanations and details provided with respect to the core and the apparatus can be applied to the method.

In embodiments, the method can include rotating the first disc, the second disc, or a combination thereof, of a core as described throughout this disclosure, thereby drawing a material into the core, accelerating the material, and colliding the material with itself between the plurality of hypersonic blades of the first disc and the plurality of hypersonic blades of the second disc, thereby producing nanoparticles of the material.

In embodiments, the method may further include modifying an atmosphere within the core, such as during the rotation of at least one of the discs. For example, one or more fluids, including gases such as inert gases, may be introduced into the core. The method may further include sintering the nanoparticles of the material. Sintering may take place in the core of the apparatus.

As the material inside the core 10 reaches hypersonic speeds, centrifugal forces may shift the trajectory of the material and may lead to an increased frequency of collision. Additionally, collisions release energy, such as an amount of energy which previously kept the material bonded together. As the separated material is generally denser than the surrounding medium, it may be difficult for this energy to disperse in the surrounding material. Therefore, this energy may affect the collided material, for example leading to stress-related cracking and polarization of the surface of the collided material.

In embodiments, the Coanda effect may be generated during the use of core 10 and apparatus 31. This effect may increase the charge on the surface of the hypersonic blades 17 and may help to repel material away from the blades, helping to reduce blade damage.

In embodiments, the method may further include producing hydrogen from the collision of the produced nanoparticles, for example in the core of the apparatus or in the cyclonic separator (or centrifugal separator) of the apparatus. Nanoparticles from an oxidizing metallic material may react with surrounding water, thereby producing hydrogen.

In embodiments, the apparatus may be configured to generate hydrogen (H₂) during the colliding of the material. An example of the use of an apparatus to generate hydrogen can be found in European Patent Application No. 23383307, which has been filed as U.S. patent application Ser. No. 18/589,002, both of which are incorporated by reference herein in their entirety. Colliding an oxidizing metallic material can activate the material such that the produced nanoparticles are able to react with water molecules (in embodiments wherein the material is dispersed in water during the colliding process), in particular without adding a base such as potassium or sodium hydroxide (KOH and NaOH). Alkaline water may be used but is not required. A metallic material herein may include both metals such as iron, aluminum, calcium, magnesium, the like, and combinations thereof, as well as metalloids such as silicon. The oxidizing metallic material may further include a non-metallic element or compound. In embodiments, additives can be added for improving the reaction between the material and the water. For example, the use of materials such as silicon, graphene, activated carbon, or combinations thereof may help to improve the reaction between the material to be collided and the water. Such additives may also be included in the oxidizing metallic material. For example, the oxidizing metallic material may include nano-sized activated carbon or graphene. An oxidizing material may herein refer to a material which is capable of removing and capturing oxygen from a water molecule, such that hydrogen is produced in the process. Other additives that may be used are, for example, nanoparticles of iron or nickel.

In embodiments, the use of nickel may help to weaken the bonds between the hydrogen and the oxygen of the water molecules by bonding to the hydrogen atoms of the water molecules. Nickel may therefore help to promote the reaction between the material and the water molecules. Also, nickel may help to break the bonds of the water molecules, with the hydrogen atoms remaining attached to the nickel. Accordingly, the hydrogen production may also be enhanced.

Nickel may be introduced in the core in powder form, in embodiments. In other embodiments, nickel may be attached to an inside of the apparatus. For example, strips or other suitable elements including nickel, such as those made of nickel or coated with nickel, may be attached to the apparatus. A suitable location may be at the outlet of the core, such that a water dispersion with collided material may be contacted with the nickel.

In embodiments, the oxidizing material may be provided and introduced into the core in several ways. In embodiments, the oxidizing material may be directed into the apparatus in powder form and water may be added to the apparatus such that a dispersion or slurry including the powder is introduced in the core of the apparatus. In other embodiments, a dispersion or slurry of the particles in the water may be prepared prior to input to the apparatus. In other embodiments, a powder may be introduced into the core, and then the water may be added to the apparatus after the nanoparticles of the material are formed during the collision process.

Therefore, an oxidizing material may be collided in order to obtain nanoparticles, which in turn can react with water, for example seawater, without the need to use further chemical compounds. Such a reaction may effectively produce hydrogen. For example, if silicon is used, the nanoparticles of silicon produced may undergo the following reaction: Si+4H₂O→Si(OH)₄₊₂H₂. Hydrogen gas is therefore released. The silanol functional groups (Si—OH) of the orthosilicic acid (Si(OH)₄) may then form siloxane bonds (Si—O—Si) and release water: 2Si(OH)₄→(OH)₃Si—O—Si (OH) 3+H₂O. Subsequently, the released water molecules may react with the silicon nanoparticles which have not reacted yet, sustaining the production of hydrogen gas until the silicon nanoparticles have been consumed: 4H₂O+Si→Si(OH)₄+2H₂.

The chemical reactions above may cause the pH to decrease, and a decrease in pH can increase the kinetics of the reaction. For example, a pH below 5 may help to speed up the process as well as to increase the reactivity of the Si nanoparticles. However, this reactivity will depend on which additive(s) and in which amount additives are added (if added at all). It may also be possible that the pH increases, in embodiments. In embodiments, an acidic solution, such as one including orthosilicic acid (Si (OH) 4), may be added to accelerate the process for generating hydrogen gas.

In embodiments, hydrogen may be produced in a cyclonic separator, or for example in a centrifugal separator if such a component is used instead. The hydrogen may be collected from the top of the cyclonic separator and any remaining liquid may be collected from the bottom of the cyclonic separator. Hydrogen may also be produced in, and collected from, the core of the apparatus, in embodiments.

Although not necessary, a hydroxide compound such as potassium hydroxide or sodium hydroxide (KOH or NaOH) may be used to trigger or initiate hydrogen production. Adding a hydroxide compound may, in embodiments, accelerate the reaction between the nanoparticles and the water. As KOH or NaOH may be used to initiate the reaction, and not to extend the reaction, a small or catalytic amount of KOH or NaOH may be sufficient.

It should also be noted that nanoparticles suitable for producing hydrogen with the apparatus described herein may also be used outside the apparatus. For example, the nanoparticles may be mixed with water, including seawater, for producing hydrogen in a suitable container outside the apparatus. For example, a reactor may be used for producing the hydrogen. The reactor may be operatively connected to the apparatus, in embodiments.

A core as described herein and an apparatus as described herein may be used to produce particles, optionally nanoparticles, as well as to sinter the material. In particular, smaller particles obtained in the core after colliding material may be sintered. The produced material may be a dispersion, in embodiments. For example, the produced particles may be dispersed in water.

Particular aspects, embodiments and elements of aspects or embodiments disclosed herein can be combined together in any number and order to form new aspects and embodiments that form part of this disclosure.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is not limited to the particular systems, devices and methods described, as these may vary. The terminology used in the description is for the purpose of describing the particular versions or embodiments only and is not intended to limit the scope. In fact, it will be apparent to those skilled in the art that various modifications and variations can be made in the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “including” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “including” means “including, but not limited to.”

As used herein, the term “about” means plus or minus 10% of the numerical value of the number with which it is being used. For example, “about 50%” means in the range of 45-55%, and also includes exactly 50%. That is, any value herein modified by “about” also discloses the value itself.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. An apparatus for producing nanoparticles of a material, comprising:
a core for accelerating the material, wherein the core comprises:
a first disc and a second disc facing the first disc, and one or more drives for rotating the first disc, the second disc, or a combination thereof, wherein the first disc and the second disc each comprise:
a plurality of concentric rings, wherein each of the plurality of the concentric rings comprises a blade base and a plurality of hypersonic blades arranged on the blade base;
a plurality of concentric channels alternately interleaved with the plurality of concentric rings;
wherein each of the plurality of hypersonic blades comprises a sharp leading edge, a sharp trailing edge, a suction surface, and a pressure surface configured to produce an expansion wave;
wherein each of the plurality of hypersonic blades of the plurality of concentric rings of the first disc are arranged in the channels of the second disc; and
wherein each of the plurality of hypersonic blades of the plurality of concentric rings of the second disc are arranged in the channels of the first disc.

2. The apparatus of claim 1, wherein the one or more drives are configured to rotate the first disc in a first direction and the second disc in a second direction, opposite to the first direction.

3. The apparatus of claim 1, further comprising:
an inlet for introducing the material in the apparatus; and
a material guide for guiding the material to the core.

4. The apparatus of claim 1, wherein the first disc, the second disc, or a combination thereof comprise an opening through which material is drawn into the core when the first disc, the second disc, or a combination thereof are rotated.

5. The apparatus of claim 1, further comprising a system for setting an atmosphere within a path of the apparatus through which the material is to travel.

6. The apparatus of claim 1, further comprising a system for generating a vacuum for removing the nanoparticles of the material from the core.

7. The apparatus of claim 1, further comprising a separator system for separating the nanoparticles of the material from a surrounding medium.

8. The apparatus of claim 1, further comprising a collection system configured to collect the nanoparticles of the material.

9. The apparatus of claim 1, wherein a chord length of each of the plurality of hypersonic blades decreases from a most radially inner ring towards a most radially outer ring.

10. The apparatus of claim 1, wherein a pitch of each of the plurality of hypersonic blades increases from a radially most inner ring towards a radially most outer ring.

11. The apparatus of claim 1, wherein the first disc and the second disc comprise a ceramic material.

12. The apparatus of claim 1, wherein the core further comprises:
a housing enclosing the first disc and the second disc;
wherein the housing further comprises one or more elements for acting on an atmosphere between the first disc and the second disc.

13. The apparatus of claim 12, further configured to adjust a sintering process within the core.

14. A method for producing nanoparticles of a material, comprising:
rotating the first disc, the second disc, or a combination thereof of an apparatus comprising:
a core for accelerating the material, wherein the core comprises:
a first disc and a second disc facing the first disc, and one or more drives for rotating the first disc, the second disc, or a combination thereof, wherein the first disc and the second disc each comprise:
a plurality of concentric rings, wherein each of the plurality of the concentric rings comprises a blade base and a plurality of hypersonic blades arranged on the blade base;
a plurality of concentric channels alternately interleaved with the plurality of concentric rings;
wherein each of the plurality of hypersonic blades comprises a sharp leading edge, a sharp trailing edge, a suction surface, and a pressure surface configured to produce an expansion wave;
thereby drawing the material into the core;
accelerating the material; and
colliding the material between the plurality of hypersonic blades of the first disc and the plurality of hypersonic blades of the second disc, thereby producing nanoparticles of the material.

15. The method of claim 14, further comprising modifying an atmosphere within the core.

16. The method of claim 14, further comprising colliding the material a plurality of times.

17. The method of claim 14, further comprising producing hydrogen during the colliding of the material.

18. The method of claim 14, further comprising adding an additive to the core.

19. The method of claim 18, wherein the additive comprises silicon, nickel, graphene, activated carbon, potassium hydroxide, sodium hydroxide, or combinations thereof.

20. The method of claim 14, further comprising sintering the nanoparticles of the material.
